(19) United States
(12) Patent Application Publication
(10) Pub. No.: US 2010/0264805 A1
(43) Pub. Date: Oct. 21, 2010

(54) UNDER-GATE FIELD EMISSION TRIODE WITH CHARGE DISSIPATION LAYER

(75) Inventors: Adam Fennimore, Wilmington, DE (US); Lap-Tak Andrew Cheng, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington (DE)

(21) Appl. No.: 12/677,577

(22) PCT Filed: Oct. 3, 2008
(86) PCT No.: PCT/US08/78651

§ 371 Date: Mar. 11, 2010

Related U.S. Application Data
(60) Provisional application No. 60/977,683, filed on Oct. 5, 2007.

(51) Int. Cl. H01J 21/10; H01J 1/52

(52) U.S. Cl. 313/308; 313/313

(57) ABSTRACT

Under-gate field emission triode devices, and cathode assemblies for use therein, contain a charge dissipation layer. The charge dissipation layer may be located under or over the cathode electrode and/or electron field emitter.

This application claims priority under 35 U.S.C. §119(e) from, and claims the benefit of, U.S. Provisional Application No. 60/977,683, filed Oct. 5, 2007, which is by this reference incorporated in its entirety as a part hereof for all purposes.

### TECHNICAL FIELD

This invention relates to field emission triode devices, and to cathode assemblies for use therein.

### BACKGROUND

Traditionally, field emission triode devices have employed a design in which the gate electrode is located above the electron field emitter, and thus between the cathode electrode and the anode assembly. This design is often referred to as a “normal-gate” or “top-gate” triode device. As lower threshold electron emitting materials such as carbon nanotubes have been explored, however, two alternative geometries where the gate electrode is relocated to a different position have become feasible. The lower turn-on voltage of these new electron emitting materials, coupled with their random orientation, has made it possible for devices characterized by alternative design geometries to emit reasonable amounts of current under conditions where conventional electron emitting materials, such as Spindt tips, would be unable to emit sufficient current.

Relocation of the gate electrode has resulted primarily in a “lateral-gate” or “side-gate” geometry where the cathode and gate electrodes are coplanar, and an “under-gate” geometry where the cathode electrode is located above the gate electrode and thus between the anode assembly and gate electrode. Interest in these alternative geometries is driven by a desire to increase the ease of manufacture of field emission devices and to reduce the final device cost.

In exploring the under-gate geometry, we have found that a field emission device that has an under-gate design, particularly where carbon nanotubes (CNTs) are used as the electron emitting material, has an unexpected flaw. While emission can be obtained by applying a bias to the gate electrode, if the anode voltage is turned off, the emission current drops to an unacceptably low level when the anode voltage is turned back on. To reestablish emission current at a desirably high level, the gate voltage has to be increased substantially over its previous level. This same effect occurs each time the anode voltage is cycled off and on. It has also been found that this effect is permanent once started, and nothing has been found that can reverse this trend of increasingly higher gate voltage requirements to obtain an acceptable level of emission current. This is a most undesirable flaw because it is impossible to expect that the anode voltage would be applied continuously in any commercial consumer electronics device. Moreover, the increasingly large amounts of gate voltage required to offset the effect of the off/on cycle and produce sufficient emission current is such that the device could only be turned off and on a few times before the gate voltage required would exceed the breakdown strength of the device.

U.S. Pat. No. 5,760,535 describes a field emission triode device having a top-gate design and a charge dissipation layer. Choi et al [Diamond and Related Materials 10 (2001) 1705-1708] describe a field emission triode device having an under-gate design and a CNT electron field emitter. There nevertheless remains a need for field emission triode devices in which the deleterious effects of off/on power cycles can be minimized or avoided altogether.

### SUMMARY

This invention relates to field emission triode devices wherein an electron field emitter produces an amount of current that is characterized by a desirable degree of stability during usage in which the devices are subjected to repeated off/on cycles. This invention also relates to cathode assemblies suitable for use in such triode devices.

Features of certain of the devices and the cathode assemblies of this invention are described herein in the context of one or more specific embodiments thereof that combine various such features together. The scope of the invention is not, however, limited by the description of only certain features within any specific embodiment, and the invention also includes (1) a subcombination of fewer than all of the features of any described embodiment, which subcombination may be characterized by the absence of the features omitted to form the subcombination; (2) each of the features, individually, included within the combination of any described embodiment; and (3) other combinations of features formed by grouping only selected features of two or more described embodiments, optionally together with other features as disclosed elsewhere herein.

Some of the specific embodiments of the field emission triode devices hereof are described as follows:

One such embodiment of the devices hereof provides a field emission triode device that includes (a) a cathode assembly that includes (i) a substrate, (ii) a conductive gate electrode disposed on the substrate, (iii) an insulating layer disposed on the gate electrode, (iv) a charge dissipation layer having an electrical sheet resistance between about 1×10¹⁰ and about 1×10¹⁴ ohms per square disposed on the insulating layer, (v) a cathode electrode disposed on the charge dissipation layer, and (vi) an electron field emitter in contact with the cathode electrode; and (b) an anode.

Another embodiment of the devices hereof provides a field emission triode device that includes (a) a cathode assembly that includes (i) a substrate, (ii) a conductive gate electrode disposed on the substrate, (iii) an insulating layer disposed on the gate electrode, (iv) a cathode electrode disposed on the insulating layer, (v) a charge dissipation layer having an electrical sheet resistance between about 1×10¹⁰ and about 1×10¹⁴ ohms per square disposed on the cathode electrode and the insulating layer, and (vi) an electron field emitter disposed on the charge dissipation layer; and (b) an anode.

A further embodiment of the devices hereof provides a field emission triode device that includes (a) a cathode assembly that includes (i) a substrate, (ii) a conductive gate electrode disposed on the substrate, (iii) an insulating layer disposed on the gate electrode, (iv) a cathode electrode disposed on the insulating layer, (v) an electron field emitter in contact with the cathode, and (vi) a charge dissipation layer having an electrical sheet resistance between about 1×10¹⁰ and about 1×10¹⁴ ohms per square disposed on the insulating layer, the cathode electrode and the electron field emitter; and (b) an anode.

Some of the specific embodiments of the cathode assemblies hereof are described as follows:

One such embodiment of the cathode assemblies hereof provides a cathode assembly that includes (a) a substrate, (ii) a conductive gate electrode disposed on the substrate, (iii) an insulating layer disposed on the gate electrode, (iv) a charge dissipation layer having an electrical sheet resistance between about 1×10¹⁰ and about 1×10¹⁴ ohms per square disposed on the insulating layer, (v) a cathode electrode disposed on the charge dissipation layer, and (vi) an electron field emitter in contact with the cathode electrode.

Another embodiment of the cathode assemblies hereof provides a cathode assembly that includes (i) a substrate, (ii) a conductive gate electrode disposed on the substrate, (iii) an insulating layer disposed on the gate electrode, (iv) a cathode electrode disposed on the insulating layer, (v) a charge dissipation layer having an electrical sheet resistance between about 1×10¹⁰ and about 1×10¹⁴ ohms per square disposed on the cathode electrode and the insulating layer, and (vi) an electron field emitter disposed on the charge dissipation layer.

A further embodiment of the cathode assemblies hereof provides a cathode assembly that includes (i) a substrate, (ii) a conductive gate electrode disposed on the substrate, (iii) an insulating layer disposed on the gate electrode, (iv) a cathode electrode disposed on the insulating layer, (v) an electron field emitter in contact with the cathode, and (vi) a charge dissipation layer having an electrical sheet resistance between about 1×10¹⁰ and about 1×10¹⁴ ohms per square disposed on the insulating layer, the cathode electrode and the electron field emitter.

Other embodiments of the devices and the cathode assemblies hereof is comprised of any apparatus or device substantially as shown or described in any one or more of FIG. 6, 10, 11, 13, 14, 16 or 17.

### BRIEF DESCRIPTION OF THE DRAWINGS

FIG. 1 shows a side elevation view of a conventional, prior-art, field emission device having an under-gate design.

FIG. 2 shows the top plan view of a cathode assembly of a field emission device having an under-gate design, as disclosed in Control A.

FIG. 3 shows the side elevation view of a field emission device having an under-gate design, as disclosed in Control A.

FIG. 4 shows an image of the emission pattern obtained from the field emission device disclosed in Control A. This image was captured prior to the anode voltage being turned off for the first time.

FIG. 5 shows the gate voltages required to achieve particular emission currents for the four times the anode voltage was turned off and back then on in the field emission device disclosed in Control A.

FIG. 6 shows the side elevation view of a field emission device having an under-gate design and a charge dissipation layer, as disclosed in Example 1.

FIG. 7 shows an image of the emission pattern obtained from the field emission device disclosed in Example 1. The image was captured after the anode voltage was turn off and then back on again.

FIG. 8 shows an image of the emission pattern as viewed through the cathode substrate of the field emission device disclosed in Example 1. The image was captured after the anode voltage was turned off and then back on five times.

FIG. 9 shows an image of the emission pattern viewed through a diffuser and the cathode substrate of the field emission device disclosed in Example 1.

FIG. 10 shows the top plan view of a cathode assembly of a field emission device having an under-gate design and a charge dissipation layer, emitter lines and a grid cathode electrode (deposited in that order) as disclosed in Example 2.

FIG. 11 shows the side elevation view of the field emission device disclosed in Example 2.

FIG. 12 shows an image of the emission pattern obtained from the field emission device disclosed in Example 2.

FIG. 13 shows the top plan view of a cathode assembly of a field emission device having an under-gate design and cathode electrode lines, a charge dissipation layer and intersecting emitter lines (deposited in that order) as disclosed in Example 3.

FIG. 14 shows the side elevation view of the field emission device disclosed in Example 3.

FIG. 15 shows an image of the emission pattern obtained from the field emission device disclosed in Example 3.

FIG. 16 shows the top plan view of a cathode assembly of a field emission device having an under-gate design and cathode electrode lines, intersecting emitter lines and a thin film charge dissipation layer (deposited in that order) as disclosed in Example 4.

FIG. 17 shows the side elevation view of the field emission device disclosed in Example 4.

FIG. 18 shows an image of the emission pattern obtained from the field emission device disclosed in Example 4.

### DETAILED DESCRIPTION

There are described herein field emission triodes that have an under-gate design and contain a cathode assembly and an anode assembly. There are also described herein cathode assemblies that contain, in no particular order, a substrate, a cathode electrode, a gate electrode, an electron field emitter, an insulating layer and a charge dissipation layer. An anode assembly as used herein typically contains a substrate, an anode electrode and a phosphor layer. Incorporation of a charge dissipation layer in a cathode assembly hereof, and thus ultimately in field emission device hereof, reduces or eliminates the undesirable need to continually increase the voltage applied to the cathode electrode to maintain an acceptable level of emission current during the power off/on cycles involved in normal usage. A far more stable emission current is thereby provided in such a field emission triode device hereof.

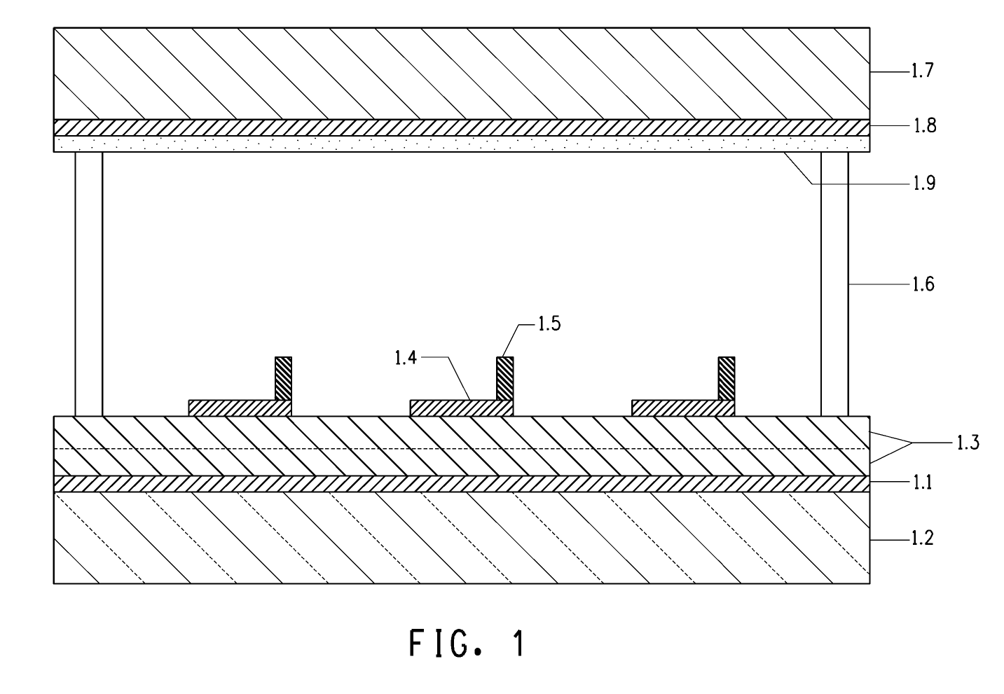

FIG. 1 shows the geometry of a conventional, prior-art field emission triode device that has an under-gate design, which, since it does not contain a charge dissipation layer, will serve as a useful point of comparison to the devices and cathode assemblies of this invention. The FIG. 1 device contains one or more gate electrodes 1.1 residing on a substrate material 1.2. The gate electrode(s) are covered by one or more insulating dielectric layers 1.3 residing thereon. Residing on the dielectric layer(s) there are one or more cathode electrodes 1.4, and electron emitting material 1.5 is in electrical contact with the cathode electrodes. Located opposite to the cathode and gate electrodes, and supported by insulating spacers 1.6, is an anode assembly that contains an anode substrate 1.7 containing one or more anode electrodes 1.8. This anode substrate may contain a phosphor coating 1.9 for the emission of light and may be maintained at a constant distance through the use of the spacers. Field emission from the electron emitting material in contact with the cathode electrode is achieved by applying a positive potential to the gate electrodes. A separate positive potential applied to the anode electrodes then attracts to the anodes electrons emitted from the emitting material. If the anode assembly contains a phosphor layer, the electron impacts will create visible light emission.

In the field emission triode devices described herein, a further element is added to the cathode assembly, namely a charge dissipation layer. The charge dissipation layer will have a sheet resistance of between about 1×10¹⁰ to about 1×10¹⁴ ohms per square as measured with an electrometer according to ASTM D257-07 Standard Test Methods for DC Resistance or Conductance of Insulating Materials. A selected resistance in the above range may be obtained by adjusting the thickness of the layer, which may range from about 10 to about 50 angstroms to about 0.1 to about 5 microns, according to the inherent resistivity of the material from which the layer is made. The charge dissipation layer will conduct excess charge to ground.

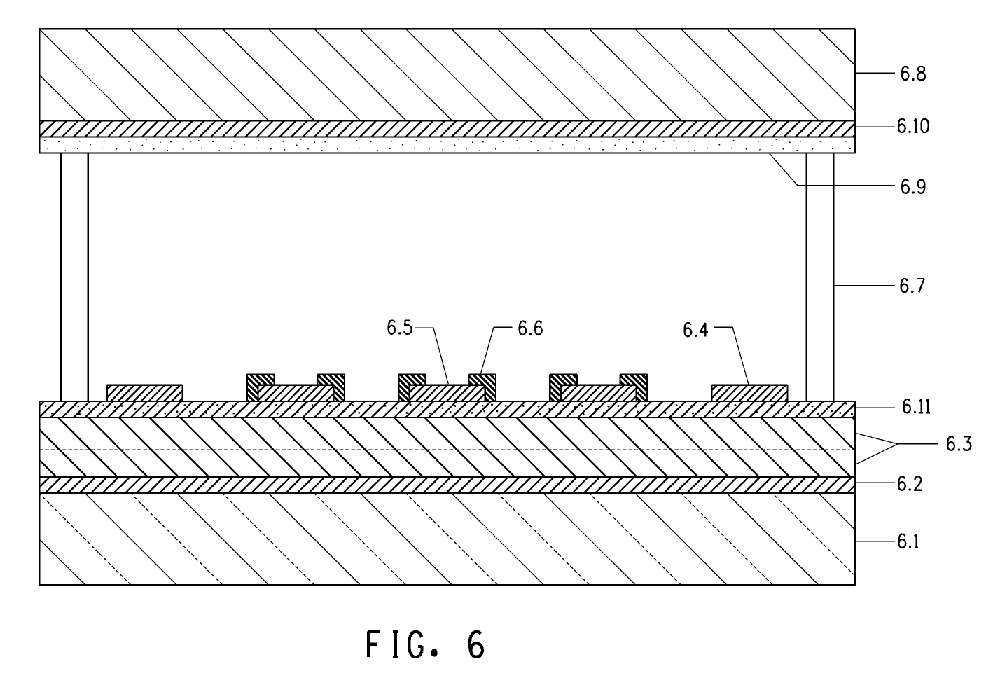

The inclusion of a charge dissipation layer in a field emission triode device of this invention may be implemented in a number of ways as there are several alternatives for the location in a cathode assembly in which a charge dissipation layer may reside. In the configuration of one embodiment, for example, a charge dissipation layer may be placed on top of an insulating layer, as formed from dielectric material, prior to the deposition of the cathode electrode and electron emitting material. Thus, once the charge dissipation layer is formed, cathode electrodes can be placed on top of it. An electron field emitter can then be placed in contact with the cathode electrodes. The electron field emitter may be located entirely on top of the cathode electrode or may have some portion located directly on top of the charge dissipation layer and some portion in contact with the cathode electrode to establish electrical contact. This type of configuration is shown in FIG. 6.

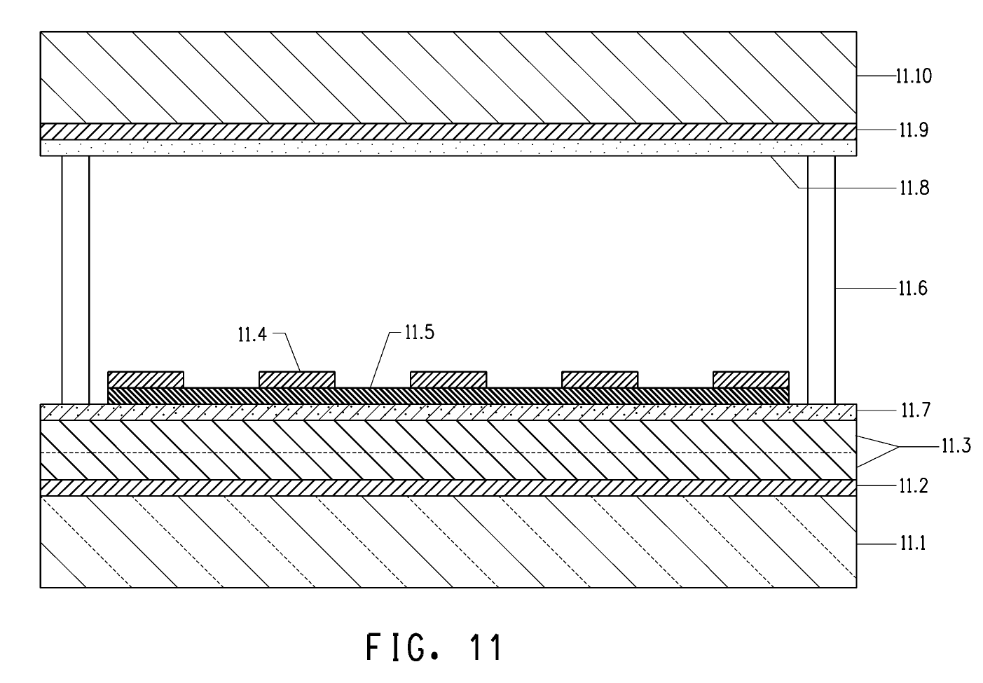

The configuration of an alternative embodiment is to place the electron emitting material of the electron field emitter on the charge dissipation layer first, and then locate the cathode electrode on top of the electron field emitter. This has the advantage of removing electron emitting material from on top of the cathode electrode, which is an arrangement prone to create ungated emission from the anode potential, also known as “hot spots”. If the electron emitting material has adequate conductivity, it may act as both the cathode electrode and electron field emitter. While this approach may also cause the occurrence of “hot spots”, the elimination of a patterning and alignment step may merit its use in some situations. This type of configuration is shown in FIG. 11.

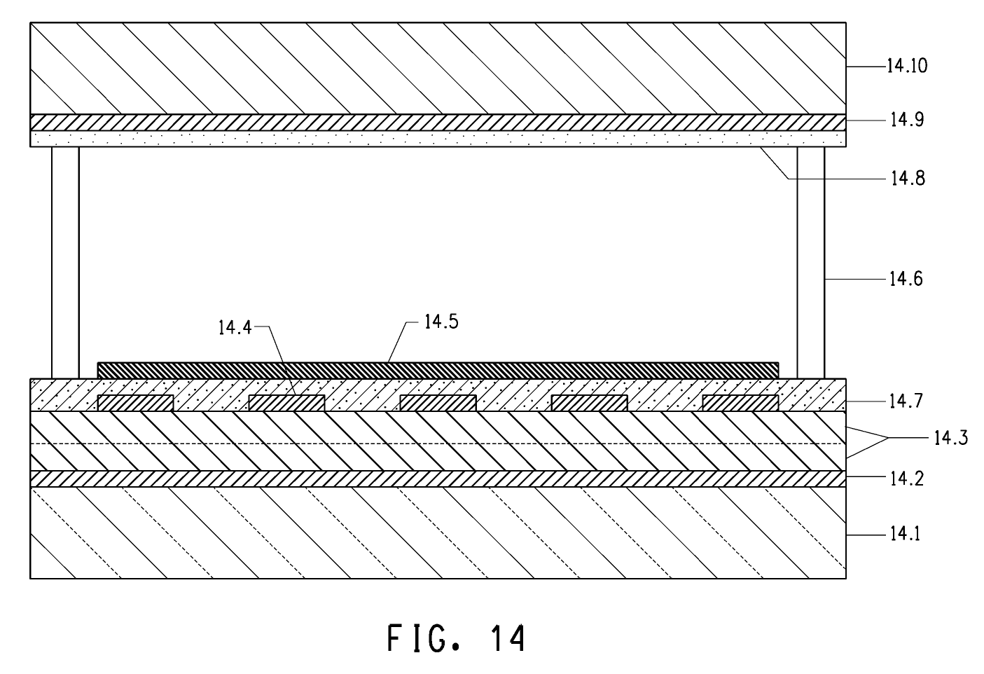

In the configuration of another embodiment, the charge dissipation layer may be located on top of the cathode electrode and beneath the electron emitting material of the electron field emitter. In addition to dissipating any surface charging that may occur, the charge dissipation layer in this instance also acts as a ballast resistor. Ballast resistors are often used in field emission devices to achieve better emission uniformity, which is an objective that is compatible with the objective of reducing the number of “hot spots” in the device. This type of configuration is shown in FIG. 14.

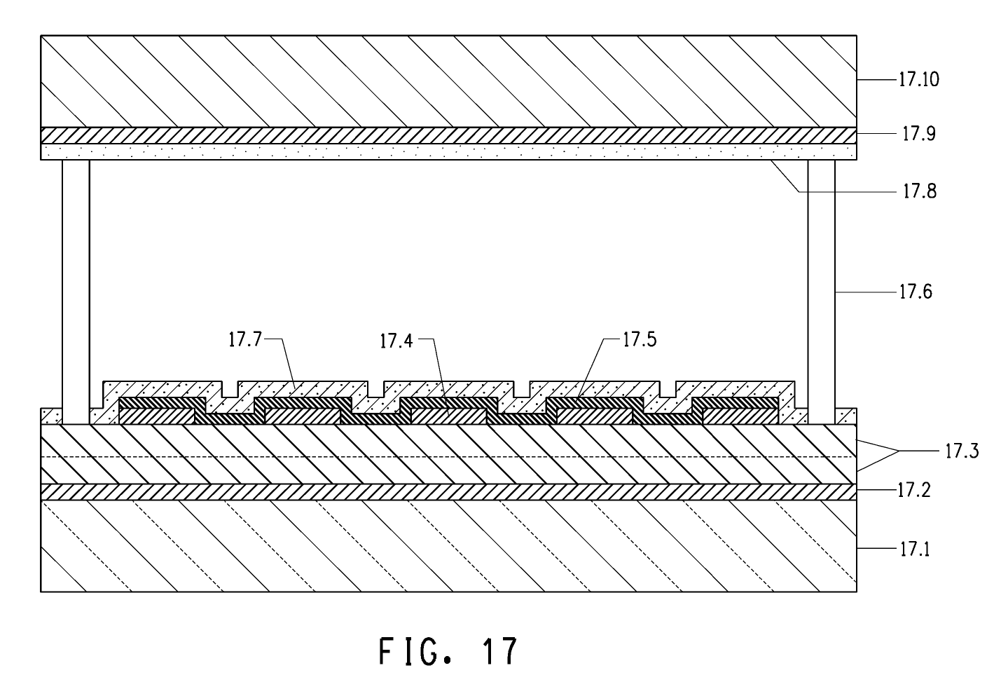

In the configuration of yet another embodiment, the charge dissipation layer may be formed after the cathode electrodes and electron field emitter have been placed on the dielectric insulating layer. This may be done through the deposition of a thin film of charge dissipation material over the entire device, or by a patterned screen print of charge dissipation material onto areas of exposed dielectric to thereby form the charge dissipation layer. The advantage to this approach is that the distance between the gate and cathode electrodes is not increased by the presence of a charge dissipation layer that has been fabricated as a thick film. This type of configuration is shown in FIG. 17.

Suitable materials for fabrication of the charge dissipation layer include without limitation one or a mixture of the typical dielectric (i.e. insulating) materials such as porcelain (ceramic), mica, glass, plastics such as epoxy, polycarbonate, polyimide, polystyrene and poly(tetrafluoroethylene), and the oxides and nitrides of various metals such as aluminum, silicon, tin and titanium. The dielectric material(s) selected may then be doped with particles of a conducting material to obtain the desired sheet resistance. Conducting materials suitable for use for such doping purpose include antimony, gold, platinum, silver or tungsten, conductive metal oxide particles such as indium doped tin oxide or fluorine doped tin oxide, or semiconductor particles such as silicon. Depending on the particles used, a doping level between 0.1% and 30% by weight based on the combined weight of the dielectric material and the dopant may be required to achieve the desired sheet resistance.

Other materials suitable for use to form the charge dissipation layer include without limitation mixed valence oxides such as cobalt iron oxide (CoO.Fe₂O₃ or CoFe₂O₄), nickel iron oxide (NiO.Fe₂O₃ or NiFe₂O₄), or nickel zinc iron oxide ([NiO+ZnO]₁Fe₂O₃ or [Ni+Zn]₁Fe₂O₄), manganese zinc iron oxide ([MnO+ZnO]₁Fe₂O₃) or even the simplest case of iron-iron oxide (FeO, Fe₂O₃) may be used. These materials are commonly known as ferrites. These include ferrite materials of the barium iron oxide and strontium iron oxide type. CoFe₂O₄ in bulk polycrystalline form may be a useful selection in various applications. Also, mixed valence oxides such as gadolinium iron oxide (Gd₃Fe₅O₁₂), lanthanum nickel oxide (LaNiO₃), lanthanum cobalt oxide (LaCoO₃) lanthanum chromium oxide (LaCrO₃), lanthanum manganese oxide (LaMnO₃) and modified materials based on these, such as lanthanum strontium manganese oxide (La_{0.67}Sr_{0.33}MnOₓ), lanthanum calcium manganese oxide (La_{0.67}Ca_{0.33}MnOₓ), or yttrium barium copper oxide (Y₁Ba₂Cu₃Oₓ), may also be used. These materials are commonly known as rare-earth and non-rare-earth mixed metal oxides.

Materials suitable for use to form a thin film of a charge dissipation layer include chromium, gold, platinum, silver or tungsten; conductive metal oxides such as indium doped tin oxide, antimony doped tin oxide, or fluorine doped tin oxide; or semiconductors such as amorphous silicon with a sheet resistance of between about 10¹⁰ and about 10¹⁴ ohms per square.

In other embodiments, the charge dissipation layer may be prepared from a composition that contains functional ingredients such as pigments or light scattering centers to provide additional functions such as light blocking or light diffusion.

Materials suitable for use herein as electron emitting materials to form an electron field emitter include acicular materials such as carbon, diamond-like carbon, a semiconductor, metal or mixtures thereof. As used herein, “acicular” means particles with aspect ratios of 10 or more. Acicular carbon can be of various types. Carbon nanotubes are the preferred acicular carbon and single wall carbon nanotubes are especially preferred. The individual single wall carbon nanotubes are extremely small, typically about 1.5 nm in diameter. The carbon nanotubes are sometimes described as graphite-like, presumably because of the sp² hybridized carbon. The wall of a carbon nanotube can be envisioned as a cylinder formed by rolling up a graphene sheet. Carbon fibers grown from the catalytic decomposition of carbon-containing gases over small metal particles are also useful as acicular carbon, each of which has graphene platelets arranged at an angle with respect to the fiber axis so that the periphery of the carbon fiber consists essentially of the edges of the graphene platelets. The angle may be an acute angle or 90°. Other examples of acicular carbon are polyacrylonitrile-based (PAN-based) carbon fibers and pitch-based carbon fibers.

The substrate in the cathode assembly or the anode assembly can be any material to which other layers will adhere. Silicon, a glass, a metal or a refractory material such as alumina can serve as the substrate. For display applications, the preferable substrate is glass, and soda lime glass is especially preferred. Materials suitable for use herein in the fabrication of the under-gate electrode, the cathode electrode and/or the anode electrode include without limitation silver, gold, molybdenum, aluminum, oxides of nickel, platinum, tin and tungsten.

One method of forming a charge dissipation layer in a cathode assembly is by the deposition, such as by screen printing, of a thick film dielectric paste that has been doped with a conductive material so as to achieve the desired sheet resistance. An alternative method is to apply a thin film coating of a resistive material such as silicon to achieve the desired sheet resistance.

An electron field emitter for use in a cathode assembly hereof, and ultimately in a field emission triode device hereof, may be prepared by admixing an electron emitting material with such glass frit, metallic powder or metallic paint (or a mixture thereof) as needed to attach the emitting material to a desired surface. The means of attachment of the electron emitting material must withstand, and maintain its integrity under, the conditions under which a cathode assembly is manufactured and the conditions under with a field emission device containing that cathode assembly are operated. Those conditions typically involve vacuum conditions and temperatures up to about 450° C. As a result, organic materials are not generally applicable for attaching particles to a surface, and the poor adhesion of many inorganic materials to carbon further limits the choice of materials that can be used. A preferred method thus is to screen print a thick film paste containing an electron emitting material and glass frit (such as a lead or bismuth glass frit), metallic powder or metallic paint (or a mixture thereof) onto a surface in the desired pattern, and to then fire the dried patterned paste. For a wider variety of applications, e.g., those requiring finer resolution, the preferred process comprises screen printing a paste that also contains a photoinitiator and a photohardenable monomer, photopatterning the dried paste, and firing the patterned paste.

The paste mixture can be screen printed using well-known screen printing techniques, e.g. by using a 165-400-mesh stainless steel screen. A thick film paste can be deposited as a continuous film or in the form of a desired pattern. When the surface is glass, the paste is then fired at a temperature of about 350° C. to about 550° C., preferably at about 450° C. to about 525° C., for about 10 minutes in nitrogen. Higher firing temperatures can be used with surfaces that can endure them provided the atmosphere is free of oxygen. However, the organic constituents in the paste are effectively volatilized at 350-450° C., leaving the layer of composite comprised of the electron emitting material and glass and/or metallic conductor. If the screen-printed paste is to be photopatterned, the paste may also contain a photoinitiator, a developable binder and a photohardenable monomer comprised, for example, of at least one addition polymerizable ethylenically unsaturated compound having at least one polymerizable ethylenic group.

Formation of the layers or components of a cathode assembly in addition to the electron field emitter, or formation of the layers or components of an anode assembly, may be achieved by thick film printing methods similar to those set forth above, or by other methods as known in the art such as sputtering or chemical vapor deposition, which may involve the use of masks and photoimagable materials where needed.

Although the deposition of various components of a cathode assembly is described in various places herein as the deposition of a thick or thin film to form a layer, and although various components of a cathode assembly when shown in a side elevation view may appear to be characterized thereby as a layer, the term “layer” as used herein does not necessarily require that a component in a cathode assembly or field emission device be wholly planar or wholly continuous. In terms of shape and layout, a component that is referred to or may be characterized as a layer may in various embodiments be or resemble a strip, line or grid, or an array of discontinuous although electrically connected pads, pegs or posts. A single layer may thus provide a plurality of positions for the location of an element of a cathode electrode, a gate electrode, a charge dissipation layer, an insulating layer and/or an electron field emitter; and an device hereof may thus contain a plurality of each of these kinds of components, which may provide for an array of individually addressable pixels.

Operation of a field emission triode device hereof involves applying appropriate potentials within ranges that include the voltages used in the examples below, via grounded voltage sources (not shown) external to the device, to a gate electrode and an anode electrode to energize the electron field emitter for the production of filed emission current.

A field emission triode device hereof may be used in a flat panel computer display, in a television and in other types of displays, and in vacuum electronic devices, emission gate amplifiers, klystrons and in lighting devices. They are particularly useful in large area flat panel displays, i.e. for displays greater than 30 inches (76 cm) in size. The flat panel displays can be planar or curved. These devices are more particularly described in US 2002/0074932, which is by this reference incorporated in its entirety as a part hereof for all purposes.

One of the advantages in employing a charge dissipation layer in a device hereof is that the stability and consistency of the emission current through numerous off/on cycles is improved. This effect is obtained, however, without sacrificing much if any of the total quantity of emission current that the device is capable of producing; and in some instances the quantity of emission current is increased by up to as much as 10 fold. This is a valuable result considering that it might have ordinarily been thought that the presence of a charge dissipation layer would cause a reduction in the effectiveness of the gate electrode because of conditions such as shielding, or reduction of the effective electric field through increased thickness. The fact that emission current remains stable and high through numerous off/on cycles indicates that little or no electron field emitter degradation is occurring in the operation of the device hereof, which is also a valuable result considering the high current loads that can exist when the apparatus is powered up, and that can exist during operation because of surface charging.

### EXAMPLES

The advantageous attributes and effects of a field emission triode device hereof may be seen in a series of examples (Examples 1-4), as described below. The embodiments of the devices hereof on which these examples are based are illustrative only, and the selection of these embodiments to illustrate the invention does not indicate that components, designs or configurations other than as described in the examples are not suitable for practicing the invention, or that subject matter other than as described in these examples is excluded from the scope of the appended claims and equivalents thereof. The significance of Examples 1-4 is better understood by comparing the results obtained therefrom with the results obtained in Control A, which involves a field emission triode device that does not contain a charge dissipation layer.

### Control A

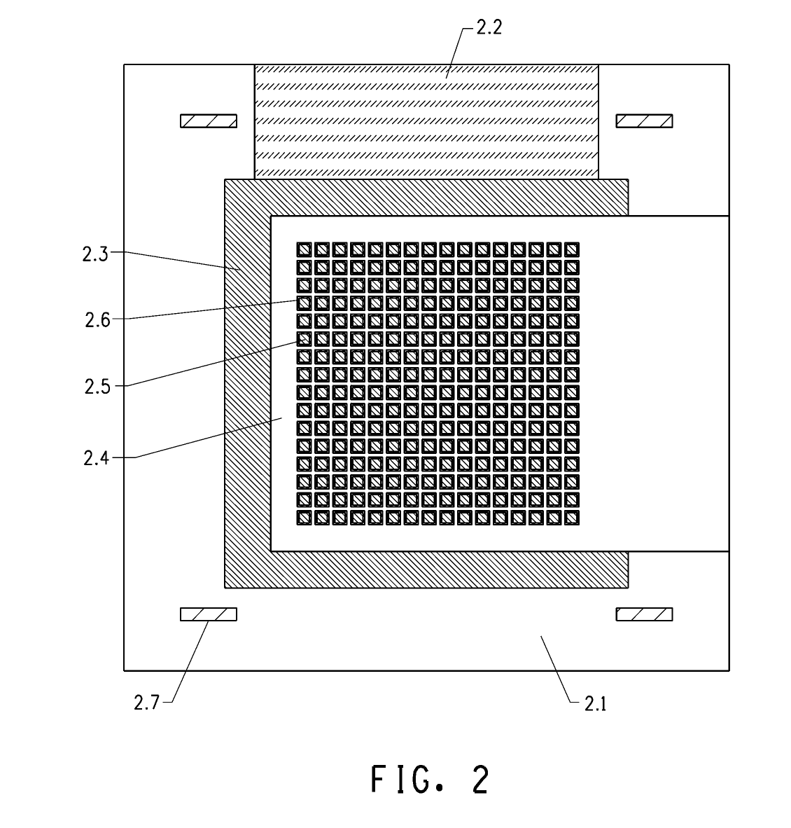

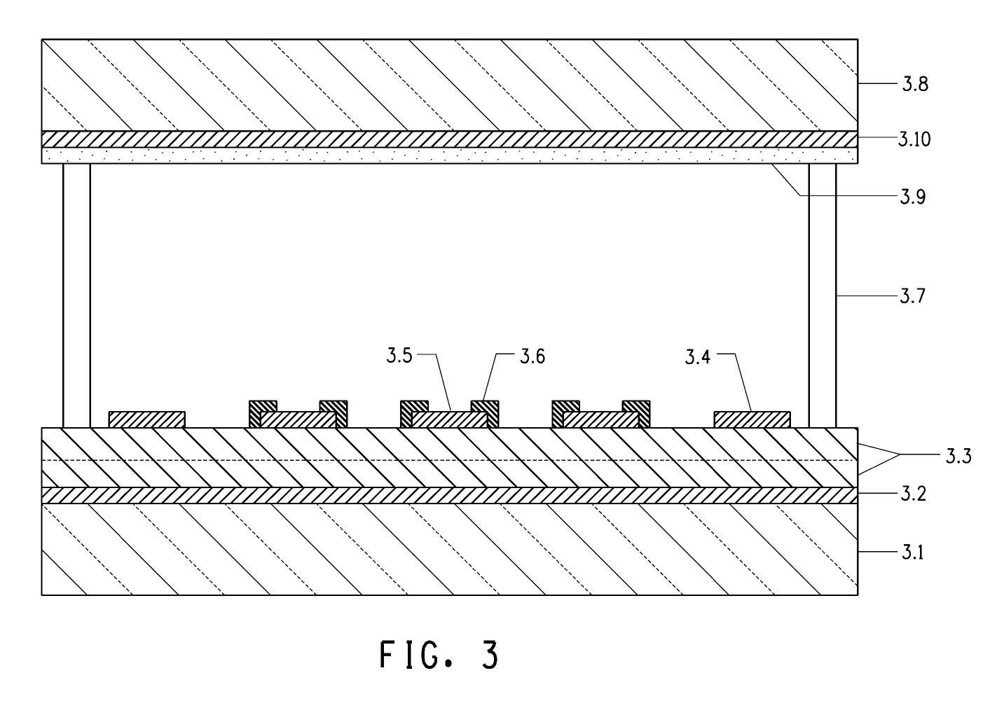

FIGS. 2 and 3 show, respectively, a top plan view of the cathode assembly of, and a side elevation view of, a field emission triode device having an under-gate design. The cathode assembly was constructed using a 2″×2″ glass substrate, 2.1 and 3.1. An ITO coating 2.2 and 3.2 on the substrate was etched to form the gate electrode. A thick film dielectric paste was screen printed on the substrate, dried at 125° C. for 5 minutes, and fired in air to a peak temperature of 550° C. for 20 minutes. A second layer of dielectric paste was screen printed on the first layer using the same procedure. The combined thickness of these two fired layers of dielectric paste was 9.3 μm, and formed an insulating layer 2.3 and 3.3 with a breakdown strength exceeding 500 V. A cathode electrode 2.4 and 3.4 was screen printed on the surface of the insulating layer using a thick film silver paste. The layer of cathode electrode was then dried at 125° C. for 5 minutes and fired with a peak temperature of 550° C. for 10 minutes.

The active area of the cathode electrode 2.5 and 3.5, which will contain the electron emitting material, consisted of a grid of 100 μm wide lines spaced at intervals of 1.5 mm. A thick film paste containing carbon nanotubes as the electron emitting material was screen printed onto the cathode electrode. The paste was subsequently dried at 125° C. for 5 minutes and fired in a nitrogen environment with a peak temperature of 420° C. The pattern of the electron field emitter 2.6 and 3.6 was patterned so that all edges of the cathode electrode in the active emission area came into contact with a line of electron emitting material that was approximately 100 μm wide. A piece of adhesive tape was then laminated over the electron field emitter and subsequently removed. This process is known to fracture the electron field emitter exposing an “activated” surface thereof.

The activated cathode assembly was then mounted opposite an anode plate consisting of an ITO coated 2″×2″ glass substrate 3.8 with a phosphor coating 3.9. Spacers 2.7 and 3.7 4 mm thick were used to maintain the distance between the cathode assembly and the anode assembly. Electrical contact was made to the ITO gate electrode, silver cathode electrode, and ITO anode electrode 3.10 using silver paint and copper tape. The device depicted in FIG. 3 was mounted in a vacuum chamber which was evacuated to a pressure of <1×10⁻⁵ Torr.

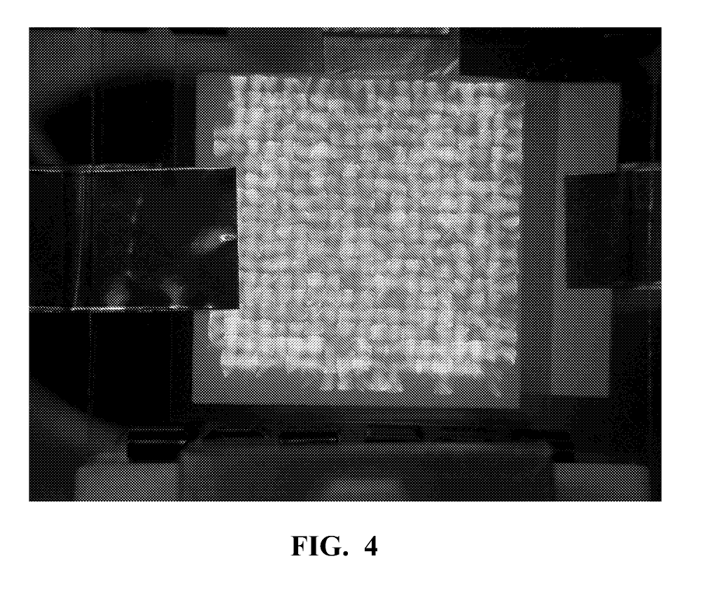

A DC voltage of 1.7 kV was applied to the anode electrode. A pulsed square wave with a repetition rate of 60 Hz and a pulse width of 60 μs was applied to the gate electrode. The cathode electrode was maintained at ground potential. When the pulsed gate voltage reached 200 V the measured DC emission current was 7.7 μA. An image of this emission pattern is shown in FIG. 4.

The anode voltage was then turned off and then back on, and, after this off/on cycle of the anode voltage, the emission current was completely gone. The anode voltage was raised to 1.75 kV, and the pulsed gate voltage was slowly raised. At a pulsed gate voltage of 275 V, the current was 0.6 μA. When the pulsed gate voltage reached 300V, the emission current was 8.7 μA, and an increase of 100 V was required in the gate potential to regain the original emission current. The anode voltage was then increased to 2.0 kV, which resulted in an emission current of 12.4 μA with a pulsed gate voltage of 300 V.

The anode voltage was then turned off again, and when the anode voltage was turned back on, the emission current was completely gone. To achieve emission again, the gate voltage was increased to 375 V where a current of 0.4 μA was achieved. At 400 V, the current was 1.5 μA, but gradually increased to 10.5 μA. Once again, an increase of 100 V in the gate potential was required to regain the previous emission current. The anode voltage was then slowly turned down to see if the emission current would once again be lost. When the anode voltage was returned to 2.0 kV the emission current was 0.0 μA.

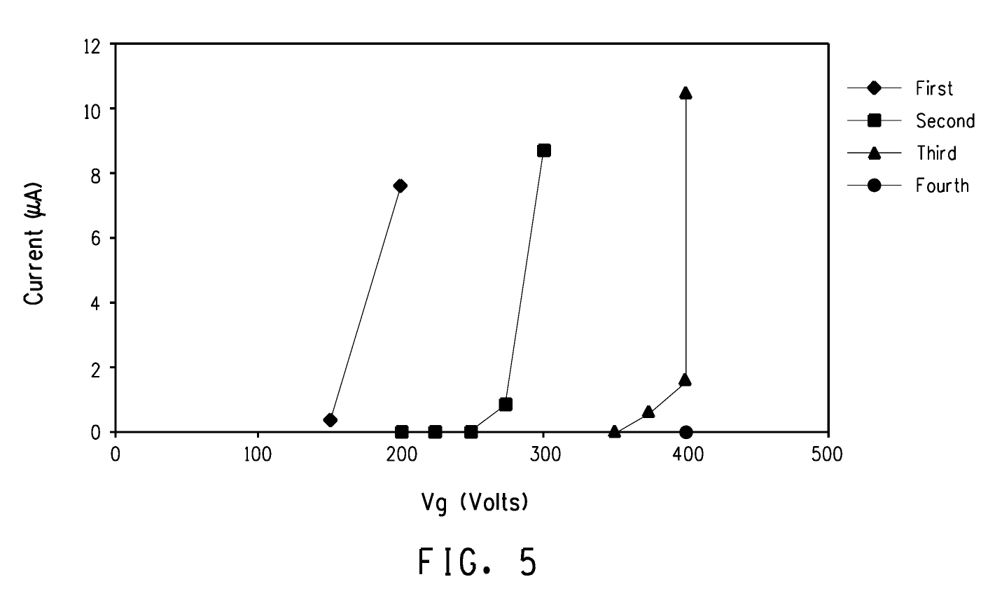

The sample was removed from the vacuum system to see if this effect could be eliminated by contact with atmosphere. However when the sample was loaded into the chamber again and an anode potential of 2.0 kV and a gate voltage of 400 V were applied, only 0.1 μA of emission were seen from a few discrete blinking spots. 400 V is close to the maximum voltage that these devices can be expected to withstand in normal operation. The drastic increase in required gate voltage each time the anode voltage was removed renders these devices unusable for real world applications. FIG. 5 shows the gate voltages required to achieve various emission currents for the four times the anode voltage was turned on.

### Example 1

A sample of another field emission triode device was made with an almost identical structure to the sample tested in Control A. In a side elevation view of the Example 1 device, FIG. 6 shows, in a manner similar to FIG. 3, the substrate 6.1 of the cathode assembly, an ITO gate electrode 6.2, an insulating layer formed from a double layer of dielectric 6.3, Ag cathode electrodes 6.4 and 6.5, CNT electron emitting material 6.6, spacers 6.7, phosphor 6.9, ITO anode electrode 6.10, and, for the anode assembly, an anode substrate 6.8. The difference between the sample device prepared in this example and the sample device prepared in Control A is that a third thick film layer was screen printed on the sample in this example prior to the patterning of the cathode electrodes. This layer 6.11, located on top of the two layers of dielectric material 6.3, consisted of a doped dielectric paste. The dielectric paste was doped with conducting particles so that it would have a finite sheet resistance greater than 10¹⁰ and less than 10¹⁴ ohm per square. Layer 6.11 will thus act as a charge dissipation layer. In this example, antimony doped tin oxide particles are used in the charge dissipation layer.

The addition of the charge dissipation layer increased the thickness of the dielectric stack to 13.1 μm. In a vacuum environment, an anode voltage and gate voltage were applied to this sample in a manner similar to that used in Control A. The device was driven at 60 Hz with 60 μsec gate pulses. At an anode voltage of 1.5 kV and a gate voltage of 200 V, the emitted current was 3.4 μA. This current is lower than the corresponding current obtained in Control A, which may be a result of the increased thickness of the dielectric stack and a reduction in surface charging assisted emission. When the anode voltage was increased to 2.0 kV and the gate voltage was increased to 300 V, the emission current was 16.5 μA.

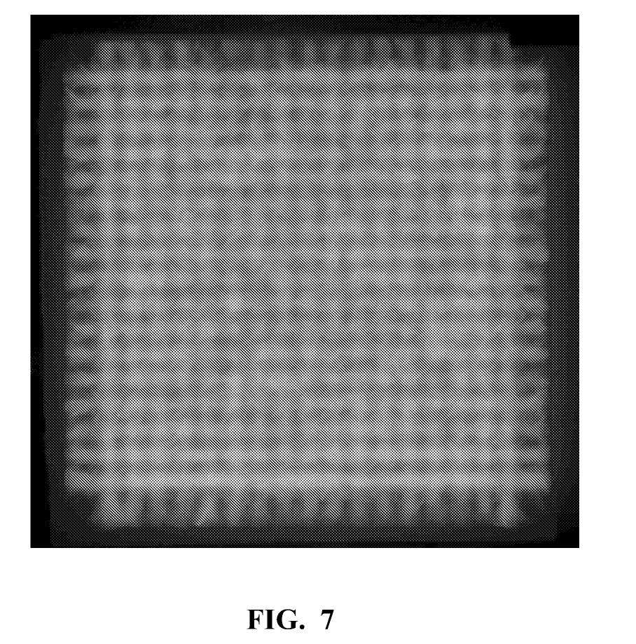

The anode voltage was turned off, and when the anode voltage was turned back on, the current returned to 14.2 μA. An image of this emission pattern captured after the anode was turn off and back on again is shown in FIG. 7. The sample device was left off overnight. When turned on again the following morning with the same settings, the emission current was 15.0 μA. The anode voltage was turned off again, and when the anode voltage was turned back on, the current was 12.1 μA.

The sample device was removed, and a metal surface was placed on the anode assembly, which caused the emitted light to be reflected towards and through the cathode substrate due to its transparent nature and the large open areas in the cathode electrode. Extraction of light through the cathode substrate rather than the anode substrate has a number of advantages. A reflective metal film is much easier to place on the exterior of the device rather than in the interior of the device on the phosphor surface. When used as a back light unit (BLU) for an LCD display in a traditional orientation, the anode substrate is located next to the LCD matrix making it difficult to cool the anode substrate. When light is extracted through the rear of the device through the cathode, the anode substrate can be located on the exterior making cooling much easier and more effective.

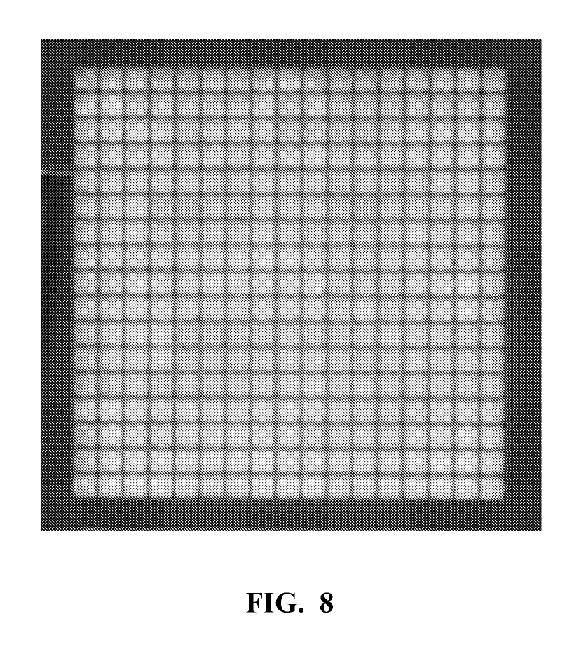

When operated with the metal surface in place, the emission current of this device stabilized at 12.0 μA for a gate voltage of 300 V and an anode voltage of 2.0 kV. The anode voltage was cycled off/on three more times in this configuration, and each time the current returned to 12.0 μA. An image of the emission obtained from this device, as viewed through the cathode substrate, is shown in FIG. 8. This image was captured after the anode voltage was turned off/on 5 times.

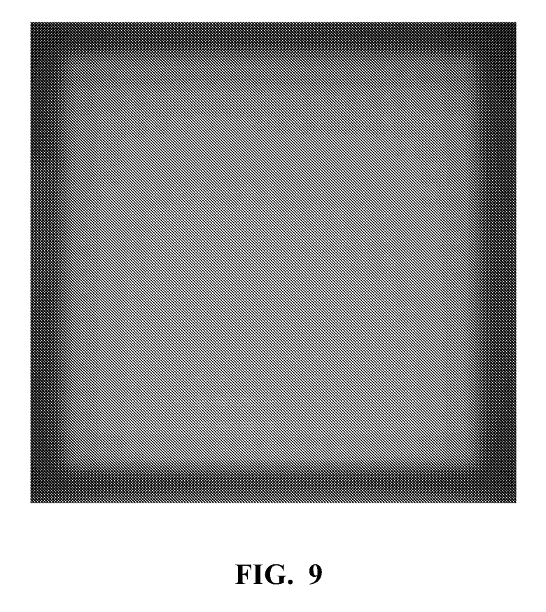

The chamber was vented and the sample was remounted with a diffuser at the exterior of the cathode substrate. This increased the uniformity of the light extracted through the cathode. An image of the emission obtained from this device, as viewed through a diffuser and the cathode substrate, is shown in FIG. 9. The current obtained when operated in this manner was 12.2 μA for a gate voltage of 300 V and an anode voltage of 2.0 kV. The device ran steadily at this current for 3 hrs. The cumulative emission time of this device was approximately 5 hrs. While some initial decay in the emission current was seen, once the current stabilized, the device could be turned on and off without any need to increase the gate voltage.

### Example 2

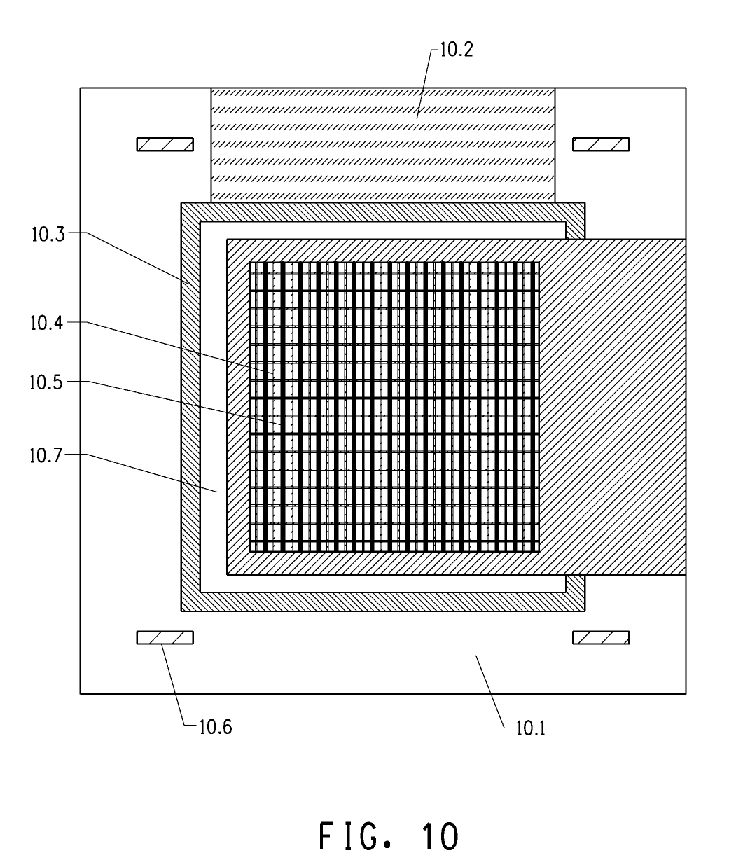

A field emission triode device having an under-gate design, similar to the device used in Example 1, was made. The primary differences between the Example 1 device and the Example 2 device were the pattern of the electron field emitter and the cathode electrodes, and the order in which these were patterned. The top plan view of the cathode assembly, and the side elevation view of the device, are shown in FIGS. 10 and 11, respectively. In those figures, there are shown the cathode substrate 10.1 and 11.1, ITO gate electrode 10.2 and 11.2, insulating layer formed from a double layer of dielectric 10.3 and 11.3, Ag cathode electrodes 10.4 and 11.4, CNT electron emitting material 10.5 and 11.5, spacers 10.6 and 11.6, charge dissipation layer 10.7 and 11.7, phosphor layer 11.8, ITO anode electrode 11.9, and anode substrate 11.10.

In a manner similar to the construction of the sample devices used in Control A and Example 1, the cathode electrode of this Example 2 device was a grid except that the spacing was 1 mm. The use of a grid electrode instead of line electrode avoids the problem of breaking electrical connectivity to an extended area of a device from just a single line break defect. The pattern of the electron field emitter was a series of 100 μm thick parallel lines spaced at an interval of 1 mm. The emitter lines make electrical contact to the cathode grid by intersecting with one set of the electrode grid lines. In this intersecting arrangement of the cathode electrode and emitter lines, electrical contact can be assured with high tolerance of any registration error. Therefore this device can be fabricated without the use of costly precision printing or lithographic equipment.

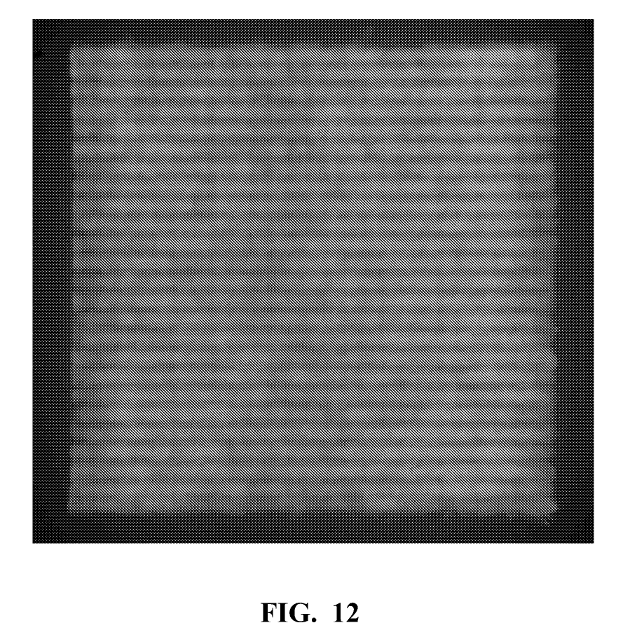

An image of the emission pattern obtained from this Example 2 device is shown in FIG. 12. The image was captured when the device was operating at an anode voltage of 3 kV, gate voltage of 300 V and anode current of 28 μA. The device was driven at 120 Hz with 30 μsec gate pulses. No ungated emission or “hot spots” were observed when the gate voltage was turned off.

In Control A and Example 1, the electron emitting material was printed after the cathode electrodes were printed, but in Example 2 the electron emitting material was printed prior to the cathode electrode. The cathode electrode was patterned on top of the electron field emitter lines such that the emitter lines approximately bisected the squares of cathode electrode. This change in design and patterning order caused a decrease in the amount of ungated emission or “hot spots” that were seen. The anode voltage could be increased to 3.0 kV without any evidence of hot spots.

Although the invention is not limited to any particular theory of operation, this decrease in “hot spots” may have resulted from three conditions. First the electron emitting material that was on top of the cathode electrode, which was the most susceptible to ungated emission, was eliminated by reversing the patterning order. By limiting the amount of material in direct contact with the cathode electrode, the electron field emitter and the charge dissipation layer could act as ballast resistors preventing hot spots from forming from a majority of material. Lastly, the material in close proximity to the cathode electrode was effectively shielded by the cathode electrode located above it.

### Example 3

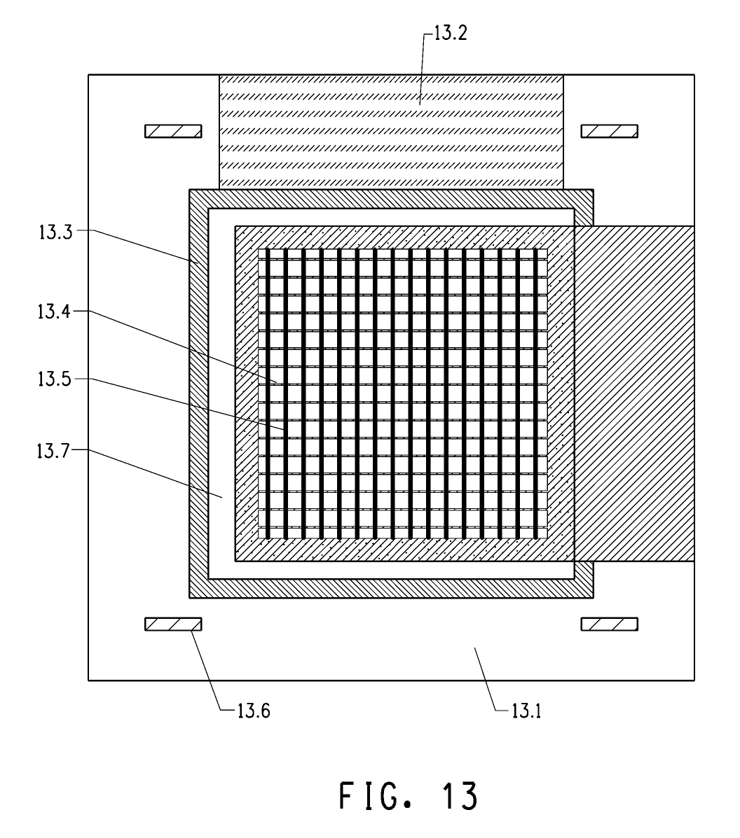

An alternative method of reducing ungated emission, or “hot spots”, was also explored. The architecture of the device in this Example 3 was similar to that of the device used in Example 1 except that the charge dissipation layer was patterned after the cathode electrode, but prior to deposition of the electron field emitter. The top plan view of the cathode assembly, and side elevation view of the device, are shown in FIGS. 13 and 14, respectively. In those figures, there are shown the cathode substrate 13.1 and 14.1, ITO gate electrode 13.2 and 14.2, insulating layer formed from a double layer of dielectric material 13.3 and 14.3, Ag cathode electrodes 13.4 and 14.4, CNT electron emitting material 13.5 and 14.5, spacers 13.6 and 14.6, charge dissipation layer 13.7 and 14.7, phosphor layer 14.8, ITO anode electrode 14.9, and anode substrate 14.10.

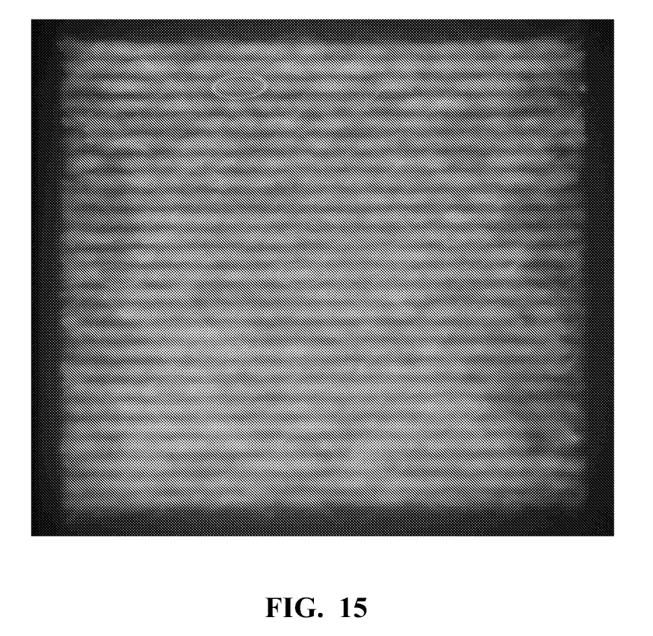

By placing the charge dissipation layer between the cathode and emitter, the charge dissipation layer could act as a ballast resistor, which would lessen the amount of ungated emission. This device could withstand an anode voltage of 2.0 kV with no “hot spots”. An image of the emission obtained from this device is shown in FIG. 15. The image was captured when the device was operating at an anode voltage of 2.25 kV, gate voltage of 300 V and anode current of 7.1 μA. The device was driven at 120 Hz with 30 μsec gate pulses. No hot spots were observed when the gate voltage was turned off.

### Example 4

As an alternative to the use of thick film dielectric coatings, a device was made employing a thin film charge dissipation layer. A charge dissipation layer of a thin chromium (Cr) film was put in place by deposition with an e-beam evaporator on top of a double layer of dielectric material, the cathode electrode, and CNT electron emitting material. The thin-film charge dissipation layer was deposited after the rest of the device had been constructed, but prior to activation of the electron field emitter. The thickness of this thin film was about 18 Å as measured by a thin film thickness crystal monitor. This film most likely comprised both chromium and chromium oxide due to impurities in the e-beam evaporator, and it possesses a finite sheet resistance greater than about 10¹⁰ and less than about 10¹⁴ ohm per square.

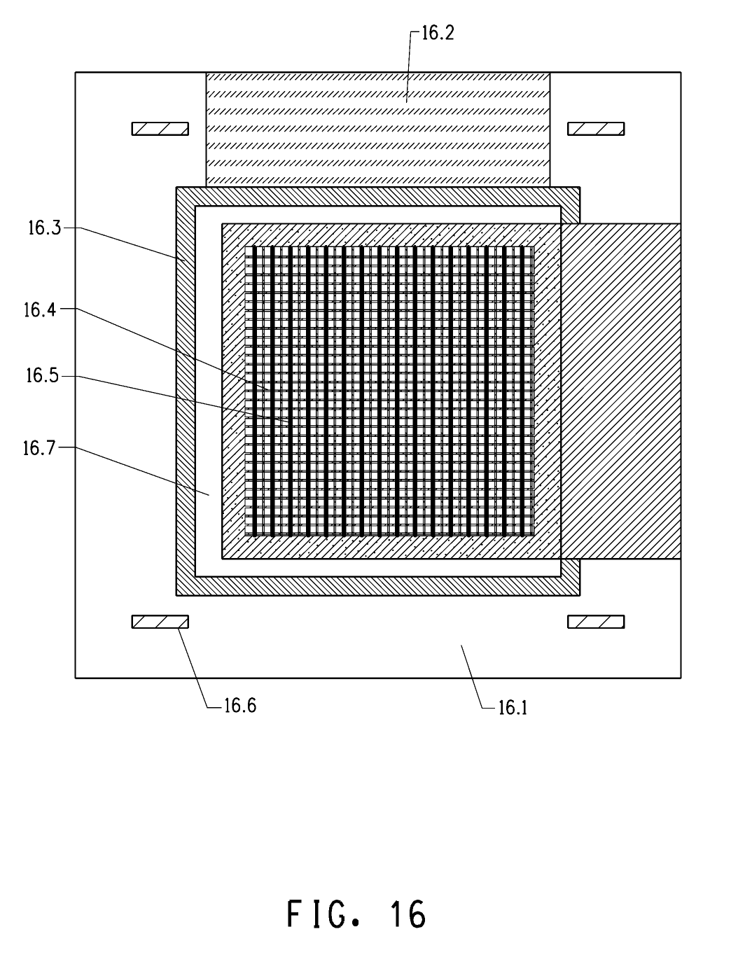

The pattern of the cathode electrode and the electron field emitter of this Example 4 device was similar to the device used in Example 2 with the exception that the CNT electron emitting material was located on top of the cathode electrode. The top plan view of the cathode assembly, and side elevation view of the device, are shown in FIGS. 16 and 17, respectively. There are shown in those figures the cathode substrate 16.1 and 17.1, ITO gate electrode 16.2 and 17.2, insulating layer formed from a double layer of dielectric material 16.3 and 17.3, Ag cathode electrodes 16.4 and 17.4, CNT emitter paste 16.5 and 17.5, spacers 16.6 and 17.6, charge dissipation layer 16.7 and 17.7, phosphor layer 17.8, ITO anode electrode 17.9, and anode substrate 17.10).

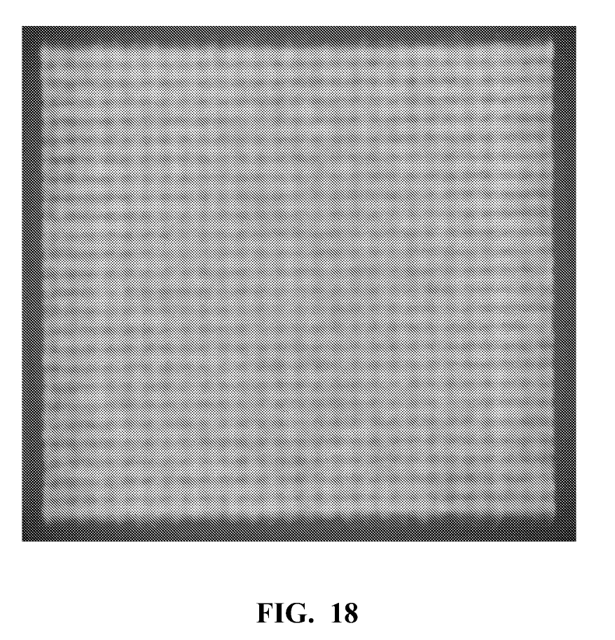

By using a thin film of Cr as the charge dissipation layer, the overall distance from the gate electrode to the electron field emitter can be reduced by about ⅓. This shorter distance allows the gate field to be more effective and reduces the required voltage for a fixed electric field. Thus the voltage needed can be greatly lowered. FIG. 18 shows the emission image obtained from the Example 4 device operating at an anode voltage of 3 kV, gate voltage of 200 V, and an anode current of 55.5 μA. The drive conditions of 120 Hz, 30 μS pulsed square wave and 4 mm anode-cathode spacing were identical to those used in Example 2, however the emitted current was far greater. At 66% of the gate voltage of Example 2, the current in this example was twice that obtained in Example 2. This is quite significant considering the nonlinear response of emission current to gate voltage. The anode and gate voltages were turned on and off without any change in the emitted current from the device, which demonstrated that the thin film charge dissipation layer produced the desired effect.

What is claimed is:

1. A field emission triode device comprising (a) a cathode assembly comprising (i) a substrate, (ii) a conductive gate electrode disposed on the substrate, (iii) an insulating layer disposed on the gate electrode, (iv) a charge dissipation layer having an electrical sheet resistance between about 1×10¹⁰ and about 1×10¹⁴ ohms per square disposed on the insulating layer, (v) a cathode electrode disposed on the charge dissipation layer, and (vi) an electron field emitter in contact with the cathode electrode; and (b) an anode.

2. A device according to claim 1 wherein the cathode electrode is disposed on a layer of electron emitting material.

3. A device according to claim 1 wherein the cathode electrode and the electron field emitter are one and the same component.

4. A device according to claim 1 wherein the cathode electrode and the electron field emitter are patterned as intersecting lines.

5. A device according to claim 1 wherein the cathode is patterned on top of the electron field emitter.

6. A device according to claim 1 wherein the electron field emitter comprises carbon nanotubes.

7. A field emission triode device comprising (a) a cathode assembly comprising (i) a substrate, (ii) a conductive gate electrode disposed on the substrate, (iii) an insulating layer disposed on the gate electrode, (iv) a cathode electrode disposed on the insulating layer, (v) a charge dissipation layer having an electrical sheet resistance between about 1×10¹⁰ and about 1×10¹⁴ ohms per square disposed on the cathode electrode and the insulating layer, and (vi) an electron field emitter disposed on the charge dissipation layer; and (b) an anode.

8. A device according to claim 7 wherein the cathode electrode and the electron field emitter are patterned as intersecting lines.

9. A device according to claim 7 wherein the cathode is patterned on top of the electron field emitter.

10. A device according to claim 7 wherein the electron field emitter comprises carbon nanotubes.

11. A field emission triode device comprising (a) a cathode assembly comprising (i) a substrate, (ii) a conductive gate electrode disposed on the substrate, (iii) an insulating layer disposed on the gate electrode, (iv) a cathode electrode disposed on the insulating layer, (v) an electron field emitter in contact with the cathode, and (vi) a charge dissipation layer having an electrical sheet resistance between about 1×10¹⁰ and about 1×10¹⁴ ohms per square disposed on the insulating layer, the cathode electrode and the electron field emitter; and (b) an anode.

12. A device according to claim 11 wherein the cathode electrode and the electron field emitter are one and the same component.

13. A device according to claim 11 wherein the charge dissipation layer is patterned on the insulating layer.

14. A device according to claim 11 wherein the cathode electrode and the electron field emitter are patterned as intersecting lines.

15. A device according to claim 11 wherein the cathode is patterned on top of the electron field emitter.

16. A device according to claim 11 wherein the electron field emitter comprises carbon nanotubes.

17. A cathode assembly comprising (a) a substrate, (ii) a conductive gate electrode disposed on the substrate, (iii) an insulating layer disposed on the gate electrode, (iv) a charge dissipation layer having an electrical sheet resistance between about 1×10¹⁰ and about 1×10¹⁴ ohms per square disposed on the insulating layer, (v) a cathode electrode disposed on the charge dissipation layer, and (vi) an electron field emitter in contact with the cathode electrode.

18. A cathode assembly comprising (i) a substrate, (ii) a conductive gate electrode disposed on the substrate, (iii) an insulating layer disposed on the gate electrode, (iv) a cathode electrode disposed on the insulating layer, (v) a charge dissipation layer having an electrical sheet resistance between about 1×10¹⁰ and about 1×10¹⁴ ohms per square disposed on the cathode electrode and the insulating layer, and (vi) an electron field emitter disposed on the charge dissipation layer.

19. A cathode assembly comprising (i) a substrate, (ii) a conductive gate electrode disposed on the substrate, (iii) an insulating layer disposed on the gate electrode, (iv) a cathode electrode disposed on the insulating layer, (v) an electron field emitter in contact with the cathode, and (vi) a charge dissipation layer having an electrical sheet resistance between about 1×10¹⁰ and about 1×10¹⁴ ohms per square disposed on the insulating layer, the cathode electrode and the electron field emitter.

20. A cathode assembly according to claim 17, 18 or 19 wherein the cathode electrode and the electron field emitter are patterned as intersecting lines.
